(19) United States
(12) Patent Application Publication
(10) Pub. No.: US 2006/0203462 A1
(43) Pub. Date: Sep. 14, 2006

(54) Systems and methods for indicating a control setting of an outdoor grill

(76) Inventor: Eric C. Stacey, Greensboro, NC (US)

Correspondence Address: JENKINS, WILSON, TAYLOR & HUNT, P. A., 3100 TOWER BLVD, SUITE 1200, DURHAM, NC, 27707, US

(21) Appl. No.: 11/374,397

(22) Filed: Mar. 13, 2006

Related U.S. Application Data
(60) Provisional application No. 60/661,361, filed on Mar. 14, 2005.

(51) Int. Cl. F21V 33/00

(52) U.S. Cl. 362/23; 362/234

(57) ABSTRACT

The presently disclosed subject is generally directed to lighting systems and methods for use with an outdoor grill wherein portions of the grill control panel and control knobs are illuminated such that the control settings of the grill are detectable in darkness and in other conditions of poor visibility.

### CROSS REFERENCE TO RELATED APPLICATION

This application is based on and claims priority to U.S. Provisional Patent Application Ser. No. 60/661,361, filed Mar. 14, 2005, herein incorporated by reference in its entirety.

### TECHNICAL FIELD

The presently disclosed subject matter relates generally to lighting systems and methods useful for indicating the control settings of an outdoor grill. More particularly, the presently disclosed subject matter is directed to lighting systems and methods for use with an outdoor grill wherein portions of the grill control panel and control knob are illuminated such that the control settings of the grill are detectable in darkness and in other conditions of poor visibility.

### BACKGROUND ART

Standard outdoor grills typically include control panels and control knobs that allow the user to maneuver the grill controls to the desired settings. Since the evening meal is the one most often cooked on a grill, it often happens that darkness descends before the grill cooking process is complete. As a result, at night and in conditions of low visibility, it is often difficult to adequately discern the various control panel and control knob settings.

Outdoor grills are characteristically located in yards, decks, and patios, away from usual light sources. As a result, alternate light sources, such as flashlights, porch lights, and floodlights have been used for grilling at night and in conditions of low visibility. However, floodlights and porch lights are typically not located in close proximity to the outdoor grill. As a result, floodlights and porch lights can prove problematic at night and in conditions of low visibility because the grill control panel and knobs are hard to discern, even with the floodlight or porch light on, resulting in difficult determination of proper grill temperature.

A further disadvantage of using a floodlight or porch light when using a grill at night and at times of reduced visibility is the constant traveling back and forth from the grill to the light switch when illumination is needed. Not only is this an inconvenience, but the light can be intrusive and disorienting to individuals with darkness-induced pupil dilation.

Using a flashlight as a light source can also be problematic when using a grill at night and in conditions of low visibility. For instance, when the flashlight is turned off, it can be hard to locate and therefore use efficiently.

It would therefore be advantageous to provide lighting apparatuses and methods to illuminate settings on the control panel and knobs of an outdoor grill for use at night and during times of reduced visibility. The presently disclosed subject matter addresses this and other deficiencies in the art.

### SUMMARY

The subject matter disclosed herein provides lighting apparatuses and methods for use with an outdoor grill to illuminate settings on the control panel and control knobs of outdoor grills at night and during times of reduced visibility.

The lighting system disclosed herein comprises a lighting device operable to emit light, a control panel, and a control knob operable to change the control of the outdoor grill between first and second control settings in response to movement of the control knob between first and second positions, respectively, with respect to the control panel. The control panel and the control knob include a portion for passing light emitted by the lighting device, wherein movement of the control knob between the first and second positions alters the light passing thorough the portion for indicating the first and second control settings, respectively, of the outdoor grill.

A method for indicating a control setting of an outdoor grill disclosed herein comprises emitting light in a first direction, providing an outdoor grill comprising a control panel, and providing a control knob operable to change control of the outdoor grill between first and second control settings in response to movement of the control knob between first and second positions, respectively, with respect to the control panel, wherein the control panel or the control knob includes a portion for passing light emitted by the lighting device, and wherein movement of the control knob between the first and second positions alters the light passing the portion for indicating the first and second control settings, respectively, of the outdoor grill.

In some embodiments, the lighting device is a light emitting diode (LED).

In some embodiments, the lighting device is affixed to the control panel.

In some embodiments, the control knob is rotatably positioned between the first and second positions.

In some embodiments, the portion of the control panel or control knob for passing light emitted by the lighting device is translucent.

In some embodiments, the portion of the control panel or control knob defines a hole for passing the light emitted by the lighting device.

In some embodiments, the portion of the control panel or control knob is a first portion, the light device operable to emit first and second light rays, the first portion passing the first light ray through the control panel, and wherein the control knob comprises a second portion for passing the second light ray through the control knob, the first and second light rays forming first and second lighting patterns when the control knob is positioned between the first and second positions, respectively, for indicating the first and second control settings, respectively, of the outdoor grill.

In some embodiments, the control knob is operable to change control of the outdoor grill between a range of different control settings when the control knob is positioned at a range of different positions between the first and second positions, and wherein the light rays emitted by the lighting device indicate a range of different control settings when the control knob is positioned at the different positions between the first and second positions.

In some embodiments, the first and second portions define first and second holes, respectively, for passing the light emitted by the lighting device.

In some embodiments, the first and second control settings are first and second temperature settings, respectively, of the outdoor grill.

It is an object of the present disclosure therefore to provide novel lighting systems for indicating a control setting of an outdoor grill. This and other objects as may become apparent from the present disclosure are achieved, at least in whole or in part, by the subject matter described herein.

### BRIEF DESCRIPTION OF THE DRAWINGS

FIG. 1 is an environment, perspective view of a grill having at least one lighted control panel and knobs according to the presently disclosed subject matter.

FIGS. 2 and 3 are cross-sectional views of a grill outfitted with a lighting apparatus according to the presently disclosed subject matter.

FIGS. 4 and 5 are overhead cut away views of a portion of a grill outfitted with a lighting apparatus according to the presently disclosed subject matter.

FIGS. 6A and 6B are perspective views of a portion of the grill shown in FIG. 1 outfitted with a lighting apparatus, wherein the control panel shows illuminated settings, and the control knobs show illuminated indicator portions.

FIGS. 7A and 7B are perspective views of a portion of the grill shown in FIG. 1 outfitted with a lighting apparatus, wherein the control panel shows illuminated indicator portions, and the control knobs show illuminated settings.

### DETAILED DESCRIPTION

While the presently disclosed subject matter is susceptible of embodiments in many different forms, there is shown in the drawings and will herein be described in detail certain embodiments of the presently disclosed subject matter with the understanding that the present disclosure is to be considered an exemplification of the principles of the disclosed subject matter and is not intended to limit the broad aspects of the subject matter to the embodiments illustrated.

The presently disclosed subject matter can take the form of an optional or standard feature for a new grill, which may be easily and efficiently manufactured and marketed. The presently disclosed subject matter can also take the form of a retrofit assembly for use on existing outdoor grills.

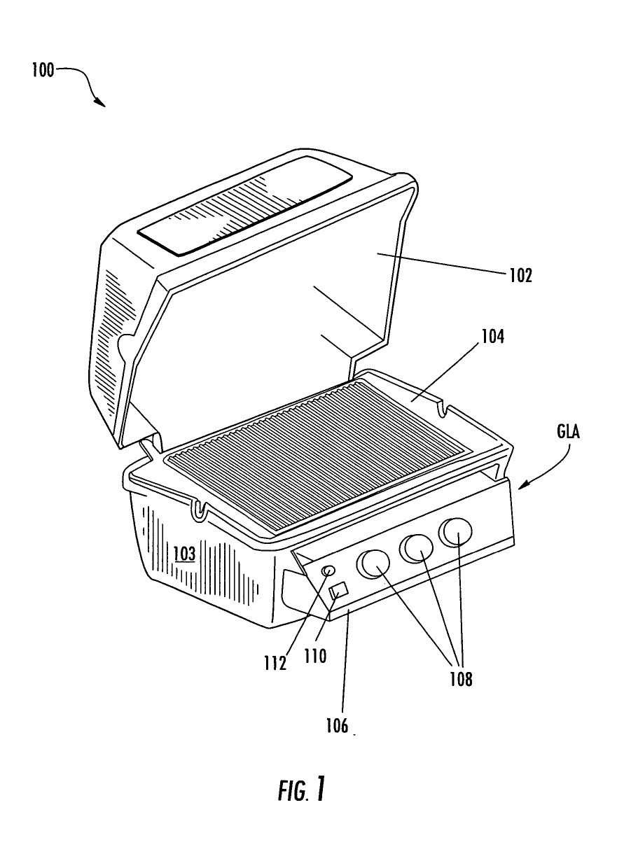

Referring now to the drawing, wherein like reference numerals refer to like parts throughout, and with particular reference to FIG. 1, a grill lighting apparatus for an outdoor grill is illustrated according to an advantageous embodiment and is generally designated GLA. Grill lighting apparatus GLA is operatively associated with an outdoor grill 100, comprising a lid 102, a base 103, and a cooking surface 104, shown for proper orientation. Generally, lighting includes a light source separate from outdoor grill 100, such as a porch light, a flashlight, and the like, needed in order to accurately view and use a control panel 106 and control knobs 108 of outdoor grill 100. It will become evident from the following description, however, that the use of grill lighting apparatus GLA as disclosed herein effectively eliminates the need for a light source separate from outdoor grill 100.

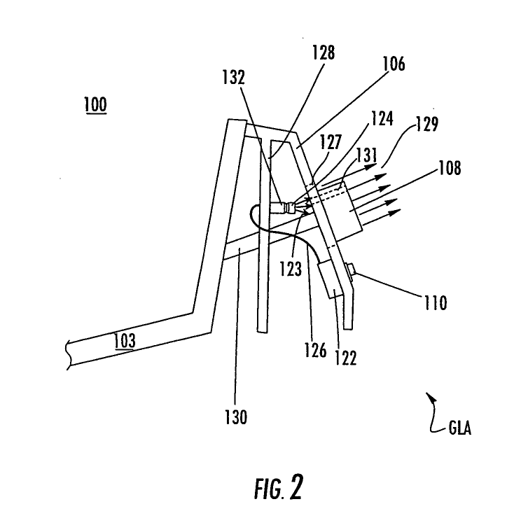

An appropriate light source for use with the presently disclosed subject matter can have any configuration suitable for transferring light to control panel 106 and control knobs 108 of outdoor grill 100. It is to be understood that control panel 106 and control knobs 108 are or can be mounted on and operatively connected to grill 100. Control panel 106 and control knobs 108 of outdoor grill 100 can receive light from a suitable lighting device, such as a light emitting diode (“LED”) 124 in FIGS. 2-5, in order to illuminate various portions of control panel 106 and control knobs 108 to allow accurate reading of the control settings of outdoor grill 100. In addition to control knobs 108 and control panel 106, grill lighting apparatus GLA additionally comprises a pushbutton switch 110 that illuminates control panel 106 and control knobs 108 when activated. Pushbutton switch 110 can be illuminated to allow for ease of location in darkness and conditions of low visibility, if desired. Further, grill lighting apparatus GLA can also comprise an igniter 112 as shown.

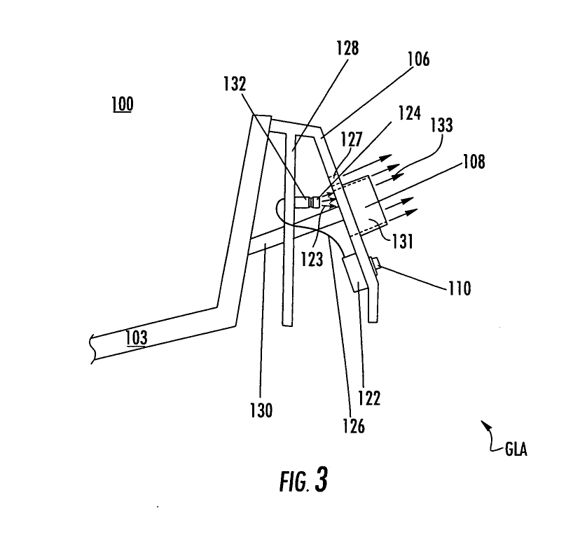

FIGS. 2 and 3 illustrate cross-sectional views of grill lighting apparatus GLA, indicating approaches by which it can be secured to outdoor grill 100. In FIGS. 2 and 3, illuminated pushbutton switch 110 is mounted to control panel 106. As would be apparent to one of ordinary skill in the art upon a review of the present disclosure, pushbutton switch 110 can be powered by and can control any of a variety of power sources mounted in any suitable method. Thus, for illustration purposes only, pushbutton switch 110 is shown powered by a battery pack 122 mounted by screw on or near the bottom back portion of control panel 106 to allow for easy battery replacement. In one embodiment, a single battery pack 122 is provided for multiple lighting devices, and is controlled though pushbutton switch 110. Alternatively, each lighting device may have its own power source provided in series. A variety of lighting devices are suitable for use with the presently disclosed subject matter. One representative lighting device is a light emitting diode (LED) shown at 124. For illustrative purposes only, LED 124 is shown secured to the panel mount LED holders 132 suitably configured. LED 124 can be connected to battery pack 122 and pushbutton switch 110 via a wire 126 running alongside manifold heat shield 128 and around control knob stem 130. Wire 126 is preferably a heat resistant type and can continue to run along heat shield 128 to connect each LED 124 to battery pack 122.

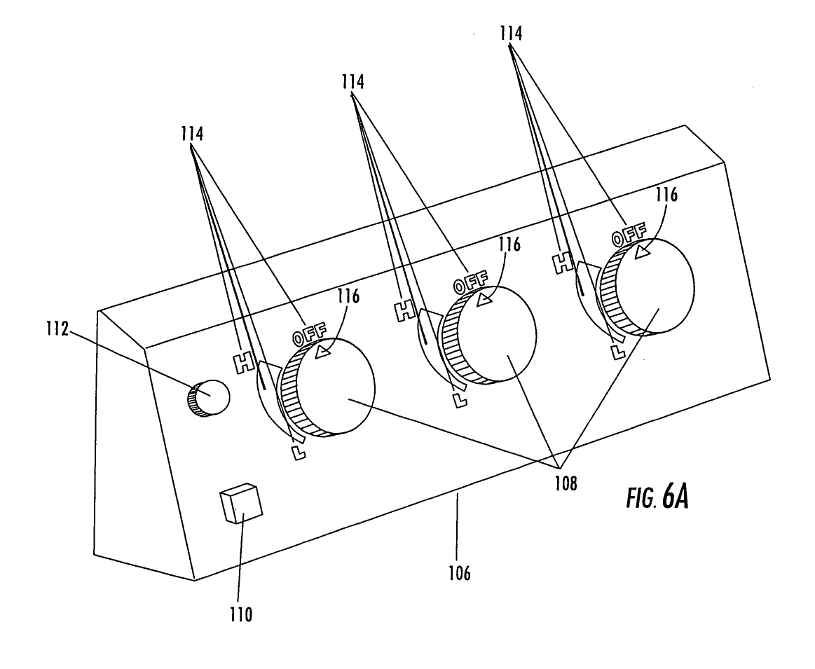

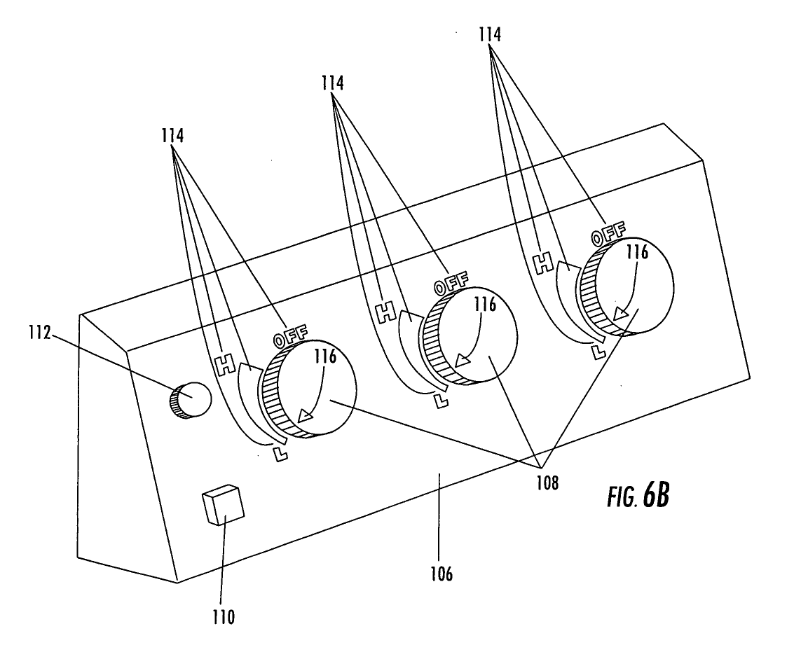

In the embodiment shown in FIGS. 2, 6A, and 6B, a control knob indicator 116 is located on each control knob 108 and control panel temperature settings 114 are adjacently located on control panel 106, allowing the operator to regulate grill control settings relative to control panel temperature settings 114. Control panel 106 can include first portion 127 for passing a portion of light rays 123 emitted by LED 124 to illuminate control panel temperature settings 114. Control knob 108 can include second portion 131 for passing a portion of light rays emitted by LED 124 to illuminate control knob indicator 116. The portions of light rays 123 passing through first and second portions 127 and 131 can form patterned light rays 129 for indicating control settings.

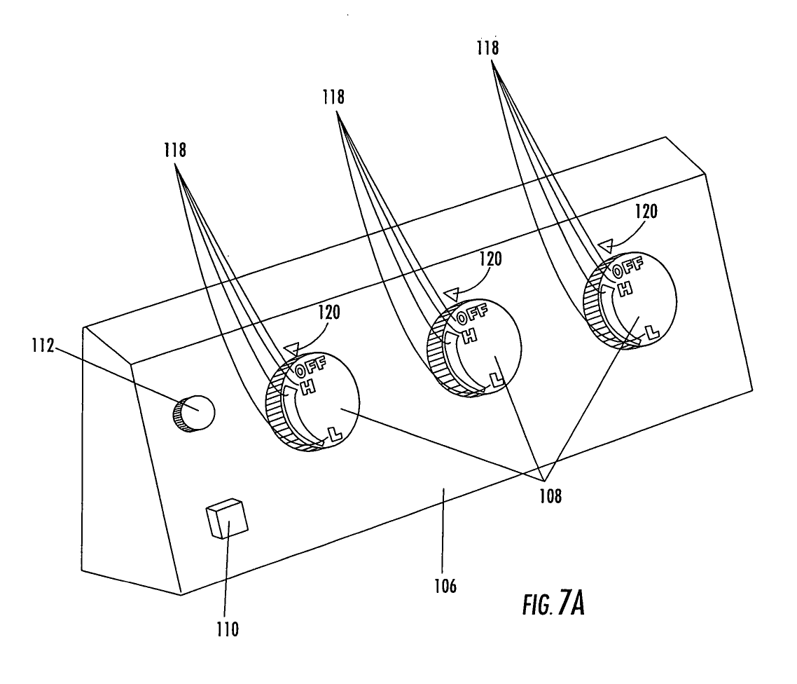

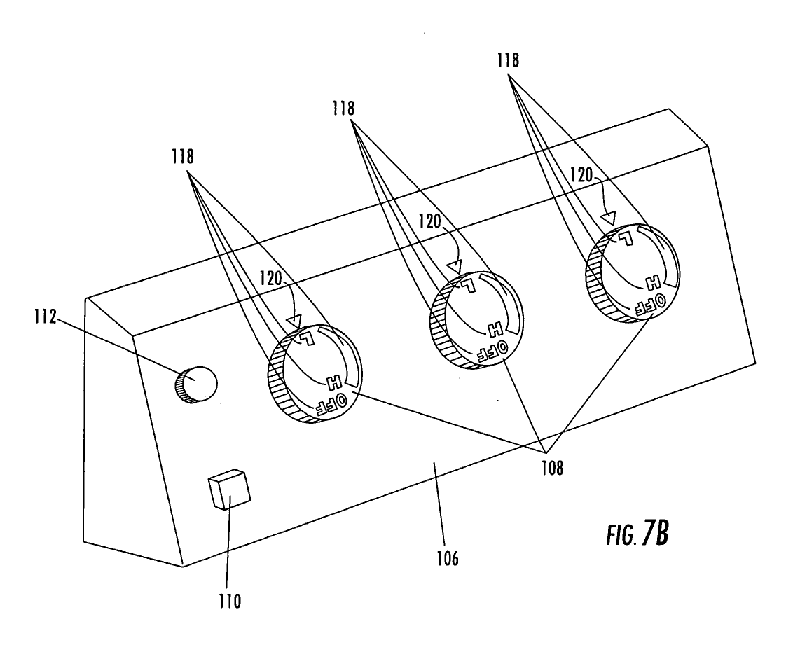

In the embodiment shown in FIGS. 3, 7A, and 7B, control knob temperature settings 118 are located on each control knob 108, and control panel indicators 120 are located on control panel 106, allowing the operator to regulate the grill control settings relative to control panel indicator 120. Control panel 106 can include a first portion 127 for passing a portion of light rays 123 emitted by LED 124 to illuminate control panel indicator 120. Control knob 108 can include second portion 131 for passing a portion of light rays emitted by LED 124 to illuminate control knob temperature settings 118. The portions of light rays 123 passing through first and second portions 127 and 131 can form patterned light rays 133 for indicating control settings.

Continuing with FIGS. 2, 3, 6A, 6B, 7A, and 7B, LED 124 can generate light rays, generally designated 123. Movement of control knob 108 between first and second positions alters a pattern of light rays (generally designated 129 in FIG. 2, 133 in FIG. 3) passing through first and second light transparent or translucent portions 127, 131 of control panel 106 and control knob 108 for indicating at least the first and second control settings of outdoor grill 100. Light rays 129, 133 form first and second lighting patterns when control knob 108 is positioned between first and second control settings. For example, control knob 108 can be rotated to different positions such that first portion 127 is in a different position with respect to second portion 131. Control knob 108 is also operable to change the controls between a range of different control settings when control knob 108 is positioned at a range of different positions between the first and second settings. Light rays 129, 133 emitted from the lighting device indicate a range of different control settings when control knob 108 is positioned at the different positions between first and second positions.

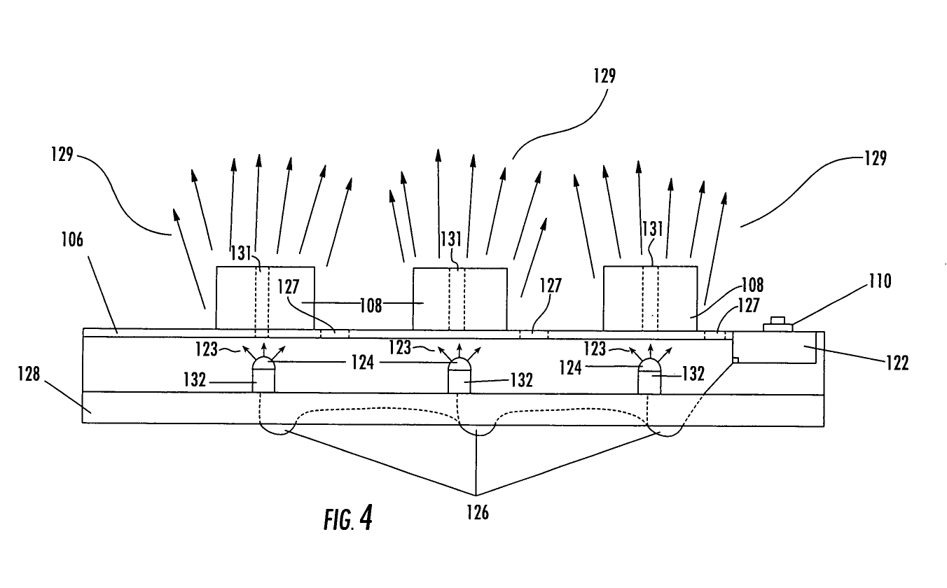

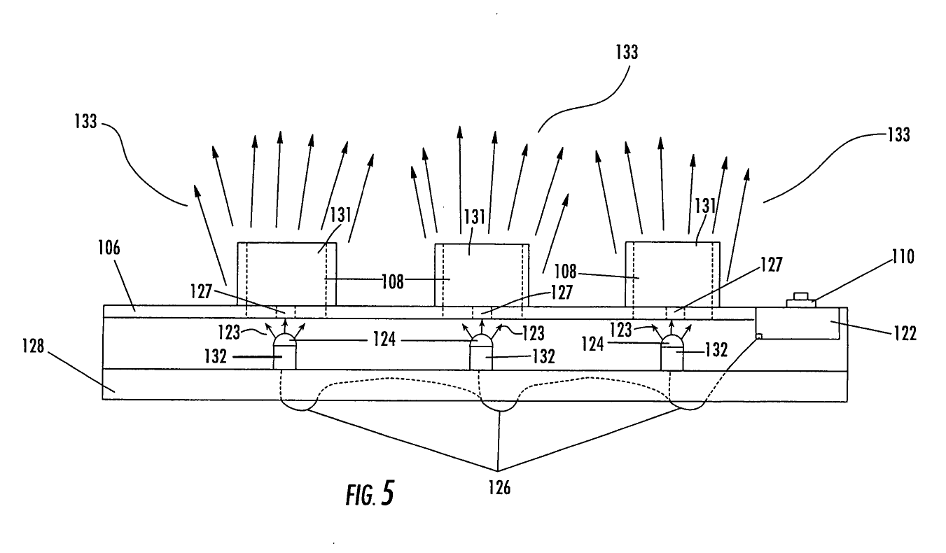

Referring now to FIGS. 4 and 5, illustrated are overhead cutaway views of control panel 106, showing wire 126 extending from battery pack 122 along heat shield 128 and connecting with LED 124. LED 124 can be secured by any suitable approach as would be apparent to one of ordinary skill in the art after a review of the present disclosure. For illustrative purposes only, LED 124 is shown secured to the panel mount LED holders 132 suitably configured. For further illustrative purposes, LED holder 132 is screwed into drilled holes located in heat shield 128. Each LED holder 132 can contain a resistor that is connected to LED 124 to limit the current in LED 124 to a safe value.

As further shown in FIGS. 4 and 5, grill lighting apparatus GLA includes three LEDs 124 positioned behind control panel 106, emitting light rays 123 outward to illuminate desired first and second portions 127, 131 to form patterned light rays 129 (FIG. 4) and 133 (FIG. 5). It will be evident to one of skill in the art that the configuration embodied in FIGS. 4 and 5 are two of many suitable configurations applicable for use with the presently disclosed subject matter.

In the embodiment shown in FIG. 4, and also in FIGS. 6A and 6B, a control knob indicator 116 is located on each control knob 108 and control panel temperature settings 114 are adjacently located on control panel 106, allowing the operator to accurately regulate grill control settings by positioning control knob indicator 116 relative to control panel temperature settings 114. Particularly, each LED 124 is positionally connected to outdoor grill 100 to emit light rays 123 through control panel 106. Control panel 106 can include first portion 127 for passing a portion of light rays 123 emitted from LED 124 through control panel 106 to illuminate control panel temperature settings 114. Control panel 106 and control knob 108 can include a second portion 131 for passing a portion of light rays 123 emitted from LED 124 through control panel 106 and control knob 108 to thereby illuminate control knob indicator 116. Thus, when illuminated pushbutton switch 110 is pushed, light rays 123 are emitted through first portion 127 of control panel 106 to illuminate control panel temperature settings 114. Further, when illuminated pushbutton switch 110 is pushed, light rays 123 are emitted through second portion 131 of control panel 106 and control knob 108 to illuminate control knob indicator 116. The portions of light rays 123 passing through first and second portions 127 and 131 can form patterned light rays 129 for indicating control settings.

In the embodiment shown in FIG. 5, and also in FIGS. 7A and 7B, control knob temperature settings 118 are located on each control knob 108, and control panel indicators 120 are adjacently located on control panel 106 allowing the operator to accurately regulate the grill control settings relative to control panel indicator 120. Particularly, each LED 124 is positionally connected to outdoor grill 100 to emit light rays 123 emitted by LED 124 through control panel 106. Control panel 106 can include a first portion 127 for passing light rays 123 emitted by LED 124 through control panel 106 to illuminate control panel indicator 120. Control panel 106 and control knob 108 can include second portion 131 for passing light rays 123 through control panel 106 and through control knob 108 to illuminate control knob temperature settings 118. Thus, when illuminated pushbutton switch 110 is pushed, light rays 123 are emitted through first portion 127 of control panel 106 to illuminate control panel indicator 120. Further, when illuminated pushbutton switch 110 is pushed, light rays 123 are emitted through second portion 131 of control panel 106 and through control knob 108 to illuminate control knob temperature settings 118. The portions of light rays 123 passing through first and second portions 127 and 131 can form patterned light rays 133 for indicating control settings.

By manipulating the appropriate control knobs 108 of control panel 106, an operator can control the settings of outdoor grill 100, and thus adjust the cooking conditions over the course of use. Generally, for the embodiments disclosed herein, the variation and adjustment of control knobs 108 in relation to control panel 106 is continuous or substantially continuous over a range between a minimum low value (which can be zero) and a maximum high value. Generally, for the embodiments disclosed herein, the variation and adjustment of outdoor grill 100 settings can be effected through the illumination and maneuvering of control knobs 108 in relation to control panel 106 in a manner described herein.

Referring again to FIGS. 6A and 6B, an embodiment of control panel 106 is schematically illustrated as an example of an implementation of grill lighting apparatus GLA. In control panel 106, control knobs 108 are maneuverable in accordance with control panel temperature settings 114 to allow the passage of light emitted from a lighting device (e.g., LED 124) located behind control panel 106 (see FIGS. 2-5). As would be understood by one of ordinary skill in the art upon a review of the present disclosure, a variety of control settings are suitable for use with the presently disclosed subject matter, in addition to the temperature control settings disclosed herein.

In the embodiment shown in FIGS. 6A and 6B, control knob indicator 116 is located on each control knob 108 and control panel temperature settings 114 are adjacently located on control panel 106, allowing the operator to accurately regulate grill control settings relative to control panel temperature settings 114. Control panel temperature settings 114 and control knob indicator 116 for passing light emitted by a lighting device can be translucent. Alternatively, control panel temperature settings 114 and control knob indicators 116 for passing light emitted by the lighting device can each be defined by a hole. Activation of the lighting device can be achieved by initiating pushbutton switch 110, allowing light to be transmitted through control panel temperature settings 114 and control knob indicator 116. The lighting device can be powered by a power source affixed to control panel 106.

As discussed hereinabove with reference to FIGS. 2-5, illumination of control panel temperature settings 114 and control knob indicators 116 can be achieved by passing light 123 emitted from a lighting device through first portion 127 and/or second portion 131, where the lighting device is operable to emit first and second light rays 129, 133. Control panel 106 can include first portion 127 to allow first light ray 129 to pass through control panel 106 to thereby illuminate control panel temperature settings 114. Control knob 108 can include second portion 131 to allow second light ray 133 to pass through control panel 106 and control knob indicator 116, whereby control knob indicator 116 is thereby illuminated. Thus, first and second portions 127, 131 allow light 123 to pass from the lighting device, to thereby illuminate control panel temperature settings 114 and control knob indicator 116 of outdoor grill 100.

Control knobs 108 can be rotatably positioned between various positions in order to control settings for grill 100. FIG. 6A illustrates control knob 108 in a first position, whereby control knob indicator 116 and control panel temperature settings 114 are aligned to set the grill controls to an off setting. FIG. 6B illustrates control knob 108 in a second position, whereby control knob indicator 116 and control panel temperature settings 114 are aligned such that the grill settings are at a low temperature setting. As would be readily understood by one of ordinary skill in the art upon a review of the present disclosure, control knobs 108 can be operable to change the controls of outdoor grill 100 between a range of different control settings when control knob 108 is positioned at a range of different positions between first and second positions, and when the light rays 123 (FIGS. 2-5) emitted by the lighting device indicate a range of different control settings when control knob 108 is positioned at the different positions between first and second positions.

Referring again to FIGS. 7A and 7B, a further embodiment of control panel 106 is schematically illustrated as an example of an implementation of grill lighting apparatus GLA. In control panel 106, control knob temperature settings 118 located on control knobs 108 are maneuverable in accordance with control panel indicators 120 to allow passage of light 123 emitted from a lighting device (e.g., LED 124 in FIGS. 2-5) located behind control panel 106. As would be understood by one of ordinary skill in the art upon a review of the present disclosure, a variety of control settings are suitable for use with the presently disclosed subject matter, in addition to the temperature control settings disclosed herein.

In the embodiment shown in FIGS. 7A and 7B, control knob temperature settings 118 are located on each control knob 108, and control panel indicators 120 are located on control panel 106 allowing the operator to accurately regulate the grill control settings relative to control panel indicator 120. Control knob temperature settings 118 and control panel indicator 120 for passing light 123 (FIGS. 2-5) emitted by a lighting device can be translucent. Alternatively, control knob temperature settings 118 and control panel indicator 120 for passing light emitted by a lighting device can be defined by a hole (see, e.g., portions 127, 131 in FIGS. 3 and 5). Control panel 106 can include a first portion 127 for passing light 123 emitted by a lighting device through control panel 106 to thereby illuminate control panel indicator 116. Control panel 106 and control knob 108 can include a second portion 131 for passing light 123 emitted by a lighting device through control panel 106 and control knob 108 to thereby illuminate control knob temperature settings 118. Activation of the lighting device can be achieved by initiating pushbutton switch 110, allowing light to be transmitted through control knob temperature settings 118 and control panel indicator 120 for passing light 123 emitted by a lighting device (e.g., LED 124 in FIGS. 2-5). The lighting device can be powered by a power source affixed to control panel 106 (e.g., battery pack 122 in FIGS. 2-5).

Control knobs 108 can be rotatably positioned between various positions in order to control grill 100 settings. FIG. 7A illustrates control knob 108 in a first position, whereby control panel indicator 120 and control knob temperature settings 118 are aligned to set the grill controls to an off setting. FIG. 7B illustrates control knob 108 in a second position, whereby control panel indicator 120 and control knob temperature settings 118 are aligned to set the grill controls to a low temperature setting. Control knobs 108 can be operable to change control of outdoor grill 100 between a range of different control settings when control knob 108 is positioned at a range of different positions between first and second positions, and when light 123 emitted by the lighting device indicate a range of different control settings when control knob 108 is positioned at the different positions between the first and second positions. The first and second positions can define first and second holes for passing the light emitted by a lighting device (e.g., LED 124 in FIGS. 2 and 3). The first and second positions can be first and second temperature settings, respectively, of outdoor grill 100.

The presently disclosed subject matter advantageously provides for grill illumination using materials sufficiently protected from the elements.

It is therefore evident from the above description that the subject matter disclosed herein provides lighting apparatuses and methods which can simply and easily be used with an outdoor grill to selectively administer light to the control panel/control knob assembly in order to more effectively control the grill control positions at night or during periods of reduced visibility. As a result, the inconvenience associated with using a separate lighting device, such as a porch light or flashlight, can be eliminated without compromising the quality of light. As would be apparent to one of ordinary skill in the art, certain features of the above-described embodiments can be interchanged or omitted from additional embodiments as desired.

Although the presently disclosed subject matter has been described with reference to certain embodiments, it is to be understood that the present disclosure has been made only by way of example, and that numerous modifications and changes may be made without departing from the spirit and scope of the presently disclosed subject matter.

What is claimed is:

1. A lighting system for indicating a control setting of an outdoor grill, the system comprising:
(a) a lighting device operable to emit light;
(b) a control panel; and
(c) a control knob operable to change control of the outdoor grill between first and second control settings in response to movement of the control knob between first and second positions, respectively, with respect to the control panel, wherein the control panel and the control knob include a portion for passing light emitted by the lighting device, and wherein movement of the control knob between the first and second positions alters the light passing through the portion for indicating the first and second control settings, respectively, of the outdoor grill.

2. The system of claim 1, wherein the lighting device is a light emitting diode (LED).

3. The system of claim 1, wherein the lighting device is affixed to the control panel.

4. The system of claim 1, wherein the control knob is rotatably positioned between the first and second positions.

5. The system of claim 1, wherein the portion is translucent.

6. The system of claim 1, wherein the portion comprises a hole for passing the light emitted by the lighting device.

7. The system of claim 1, wherein the portion is a first portion, the light device operable to emit first and second light rays, the first portion passing the first light ray through the control panel, and wherein the control knob comprises a second portion for passing the second light ray through the control knob, the first and second light rays forming first and second lighting patterns when the control knob is positioned between the first and second positions, respectively, for indicating the first and second control settings, respectively, of the outdoor grill.

8. The system of claim 7, wherein the control knob is operable to change control of the outdoor grill between a range of different control settings when the control knob is positioned at a range of different positions between the first and second positions, and wherein the light rays emitted by the lighting device indicate a range of different control settings when the control knob is positioned at the different positions between the first and second positions.

9. The system of claim 7, wherein the first and second portions define first and second holes, respectively, for passing the light emitted by the lighting device.

10. The system of claim 1, wherein the first and second control settings are first and second temperature settings, respectively, of the outdoor grill.

11. A method for indicating a control setting of an outdoor grill, the method comprising:
(a) emitting light in a first direction;
(b) providing an outdoor grill comprising a control panel; and
(c) providing a control knob operable to change control of the outdoor grill between first and second control settings in response to movement of the control knob between first and second positions, respectively, with respect to the control panel, wherein the control panel or the control knob includes a portion for passing light emitted by the lighting device, and wherein movement of the control knob between the first and second positions alters the light passing the portion for indicating the first and second control settings, respectively, of the outdoor grill.

12. The method of claim 11, wherein the control knob is rotatably positioned between the first and second positions.

13. The method of claim 11, wherein the portion is translucent.

14. The method of claim 11, wherein the portion defines a hole for passing the light emitted by the lighting device.

15. The method of claim 11, wherein the portion is a first portion, the light device operable to emit first and second light rays, the first portion passing the first light ray through the control panel, and wherein the control knob comprises a second portion for passing the second light ray through the control knob, the first and second light rays forming first and second lighting patterns when the control knob is positioned between the first and second positions, respectively, for indicating the first and second control settings, respectively, of the outdoor grill.

16. The method of claim 15, wherein the control knob is operable to change control of the outdoor grill between a range of different control settings when the control knob is positioned at a range of different positions between the first and second positions, and wherein the light rays emitted by the lighting device indicate a range of different control settings when the control knob is positioned at the different positions between the first and second positions.

17. The method of claim 15, wherein the first and second portions define first and second holes, respectively, for passing the light emitted by the lighting device.

18. The method of claim 11, wherein the first and second control settings are first and second temperature settings, respectively, of the outdoor grill.
